(19) United States
(12) Patent Application Publication
(10) Pub. No.: US 2024/0213718 A1
(43) Pub. Date: Jun. 27, 2024

(54) SELF-REBOUNDING RETURNING TYPE SOCKET CAPABLE OF PULLING PLUG WITH ONE HAND

(71) Applicant: Dongguan Dongsong Electronic Co., Ltd., Dongguan (CN)

(72) Inventor: Qiyu GAO, Dongguan (CN)

(21) Appl. No.: 18/591,063

(22) Filed: Feb. 29, 2024

(30) Foreign Application Priority Data
Jan. 5, 2024 (CN) 202410020831.9

(51) Int. Cl. H01R 13/635

(52) U.S. Cl. CPC H01R 13/635

(57) ABSTRACT

The present invention relates to a self-rebounding returning type socket capable of pulling a plug with one hand. The self-rebounding returning type socket includes a socket shell, and a terminal assembly arranged in the socket shell; a movable top cover is further arranged on the socket shell; the movable top cover is connected to elastic ejecting part modules arranged on two inner sides of the socket shell; the elastic ejecting part modules are provided with keys, by additionally arranging the elastic ejecting part modules and the movable top cover, the elastic ejecting modules can be pressed with one hand to achieve the effect of ejecting and releasing the plug, and thus pulling out the plug with one hand is achieved; and moreover, after the elastic ejecting modules are released, the movable top cover can be automatically returned to the original state of the socket without other operations.

### CROSS-REFERENCE TO RELATED APPLICATIONS

This application claims the benefit of priority from Chinese Patent Application No. 202410020831.9, filed on Jan. 5, 2024. The content of the aforementioned application, including any intervening amendments thereto, is incorporated herein by reference in its entirety.

### FIELD OF THE INVENTION

The present invention relates to the technical field of electronic and electrical equipment, and in particular to a self-rebounding returning type socket capable of pulling a plug with one hand.

### BACKGROUND OF THE INVENTION

Portable sockets and plugs are commonly devices used in people daily lives. They can be easily connected to other circuits by plugging in various wires. They are usually composed of a socket shell, and several groups of internal terminal assemblies. The terminal assemblies are connected to wires, and the socket shell is provided with a plurality of groups of sockets for plug pins to insert. During the use of ordinary non-fixed sockets, the operation of unplugging the plug is often performed with both hands, which cannot be completed with one hand or poses a risk of electric shock, causing great inconvenience to people.

Definitely, there are also some sockets that can be operated with one hand in existing technology, such as a Chinese patent “Socket” with publication number CN114336146A. Although it can achieve the function of pulling out the plug with one hand, its electrified terminal assemblies will also move with its elastic components, which may affect the service life of the socket as well as the safety of the socket. Moreover, after pulling out the plug, the socket needs to be manually returned, which is also inconvenient.

### SUMMARY OF THE INVENTION

An object of the present invention is to overcome the shortcomings in the prior art, and provides a self-rebounding returning type socket capable of pulling a plug with one hand.

According to the technical solutions adopted by the present invention, a self-rebounding returning type socket capable of pulling a plug with one hand includes a socket shell, and a terminal assembly arranged in the socket shell; a first plughole corresponding to the terminal assembly is formed in an upper cover of the socket shell; a movable top cover is also arranged above the first plughole in the upper cover of the socket shell; a second plughole corresponding to the first plughole is formed in the movable top cover; first through holes are formed in the upper cover of the socket shell and in the two sides of the first plughole respectively; connecting pins which pass through the first through holes and penetrate into the upper cover of the socket shell are arranged on two sides of the lower surface of the movable top cover respectively; the connecting pins are connected to elastic ejecting part modules arranged on two inner sides of the socket shell respectively; the elastic ejecting part modules enable the movable top cover to be in a low position in a normal state; keys exposed out of two side walls of the socket shell are arranged on the outer sides of the elastic ejecting part modules respectively; when the keys are pressed, the movable top cover is ejected out through the elastic ejecting part modules; and when the keys are released, the movable top cover is returned to the low position through the elastic ejecting part modules, and the keys are returned at the same time.

Specifically, each elastic ejecting part module is provided with a box-shaped body and a surface cover; a key is arranged on the outer side surface of the box-shaped body; second through holes aligned to the first through holes are formed in the surface cover; ejecting parts capable of penetrating through the second through holes and the first through holes are mounted in the second through holes; the upper parts of the ejecting parts are connected to the connecting pins of the movable top cover; the lower ends of the ejecting parts are connected to the upper end part of the elastic assembly arranged in the box-shaped body; the elastic assembly includes a first connecting rod, a second connecting rod and a torsional spring; the upper end part of the first connecting rod is pivoted with the ejecting part while the other end of the first connecting rod is pivoted with one end of the second connecting rod; the other end of the second connecting rod is pivoted at the inner bottom of the box-shaped body; a main body of the torsional spring is arranged on a connecting part of the first connecting rod and the second connecting rod in a sleeving manner; one end of the torsional spring is connected with the first connecting rod while the other end of the torsional spring is connected with the second connecting rod; the upper end part of the first connecting rod and the lower end part of the second connecting rod are positioned in positions close to the inner side surface of the box-shaped body; the connecting part of the first connecting rod and the second connecting rod is outwardly propped against the inner side of the key; and when the torsional spring is in a normal state, an included angle between the first connecting rod and the second connecting rod is in a decreasing trend, namely in a trend of clamping and downwards pulling the ejecting parts.

Further, two first connecting rods are arranged, and the upper end parts of the first connecting rods are pivoted with the lower parts of the ejecting parts through first connecting shafts; the upper part of the second connecting rod extends towards two ends to form connecting parts to be connected with the first connecting rods and used for sleeving the main body of the torsional spring; and the lower end part of the second connecting rod is connected with the bottom of the box-shaped body through a second connecting shaft.

A protruding to-be-pushed portion is arranged in the middle of the connecting part of each first connecting rod and the second connecting rod; and correspondingly, an upward ejecting arc surface corresponding to the to-be-pushed portion is arranged on the inner side of the key.

A limiting mechanism for preventing the key from being separated is arranged in each elastic ejecting part module; the limiting mechanism includes clamping grooves formed in two side surfaces of the box-shaped body, and buckling parts which are arranged on two side surfaces of each key and protrude outwards, and the buckling parts are limited in the transversely-arranged clamping grooves; and guide blocks are further arranged on the side surfaces and the bottom surfaces of the keys and are matched with guide grooves formed in the side surfaces and the bottom surfaces of the box-shaped bodies.

The ejecting parts are a cuboid, correspondingly, the second through holes in the surface cover and the first through holes in the upper cover are rectangular, and connecting holes which are connected to the connecting pins of the movable top cover in an inserting manner are formed in the ejecting parts. Buckles are arranged on the inner walls of the connecting holes and are matched with clamping holes of the connecting pins, so that the connecting pins and the ejecting parts are prevented from being easily loosened; and
key holes for exposing the keys of the elastic ejecting part modules are formed in two sides of the socket shell.

A concave part is arranged in the surface of the upper cover of the socket shell; and the movable top cover is arranged in the concave part, and the upper surface of the movable top cover does not protrude out of the upper surface of the upper cover of the socket shell, so that the flatness and attractiveness of the overall appearance of the socket can be guaranteed.

The socket shell includes the upper cover and a bottom cover which are integrated; the upper cover and the bottom cover are matched with each other to limit and fixedly arrange a plurality of groups of terminal assemblies; the elastic ejecting part modules are respectively arranged in spaces on two sides of each group of terminal assemblies in the socket shell; and the elastic ejecting part modules are fixedly mounted on the upper cover or the bottom cover, and are fixed by screws or clamping positions.

According to the present invention, on the basis of an existing socket, the basic arrangement and specification of original terminal assemblies are not changed, the specification of the plug pin is not changed, and the fixed state of the terminal assemblies is kept; the elastic ejecting part modules and the movable top cover are additionally arranged, the elastic ejecting modules can be pressed with one hand to achieve the effect of ejecting and releasing the plug, and thus pulling out the plug with one hand is achieved; and moreover, after the elastic ejecting modules are released, the movable top cover can be automatically returned to the original state of the socket without other operations, and thus the convenience and the safety are greatly improved. In addition, the overall appearance of the socket according to the present invention can be kept the same as or close to that of a traditional socket, so that the safety and the service life are guaranteed; and the socket has a wide market prospect.

### BRIEF DESCRIPTION OF THE DRAWINGS

FIG. 1 is a use effect diagram of an embodiment of the present invention;

FIG. 2 is a breakdown structure diagram of a socket unit in a socket according to the present invention;

FIG. 3 is a breakdown structure diagram of an elastic ejecting part module according to the present invention; and

FIG. 4 is an internal schematic diagram of an elastic ejecting part module and a schematic diagram of a mutual position relation between the elastic ejecting part module and a movable top cover according to the present invention.

### DETAILED DESCRIPTION

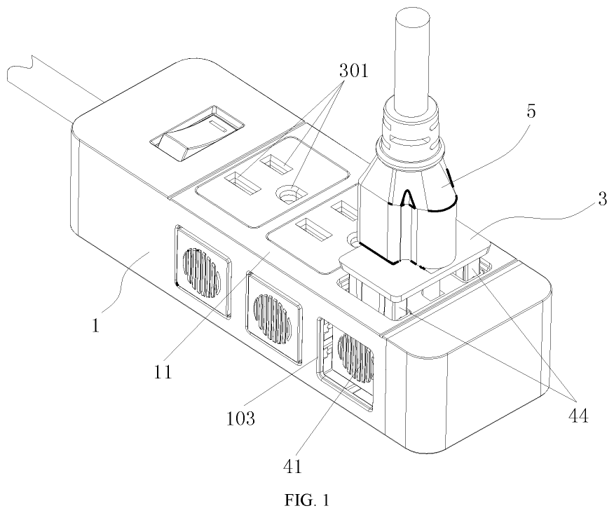

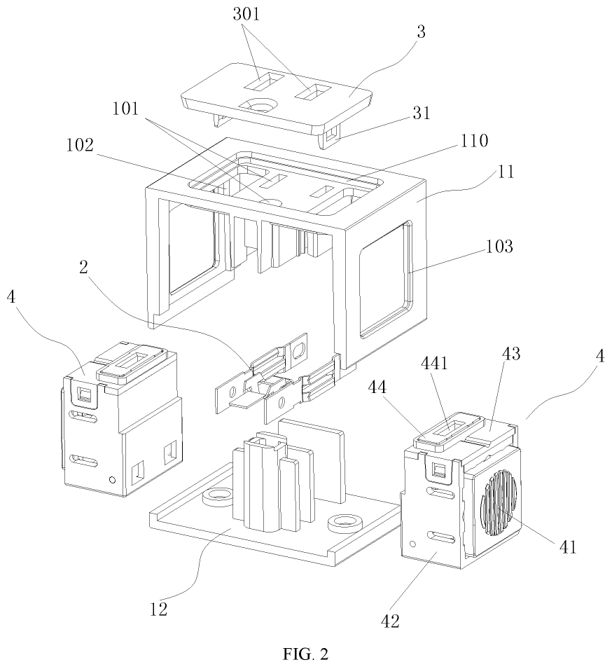

As shown in FIG. 1 and FIG. 2, the present invention provides a self-rebounding returning type socket capable of pulling a plug with one hand; the socket includes a socket shell 1, and a terminal assembly 2 arranged in the socket shell; a first plughole 101 corresponding to the terminal assembly 2 is formed in an upper cover 11 of the socket shell 1, the number and the specification of the first plughole 101 are set as required, and a single group or a plurality of groups of first plugholes may be provided for inserting metal pins of the plug; a movable top cover 3 is further arranged above each group of first plugholes 101 in the upper cover 11 of the socket shell 1; second plugholes 301 corresponding to the first plugholes 101 are formed in the movable top covers 3, and the second plugholes 301 may be slightly larger than the first plugholes 101, and are provided with guide inclined planes for smoothly guiding in the plug; first through holes 102 are formed in the upper cover 11 of the socket shell 1 and in two sides of the first plugholes 101 respectively; connecting pins 31 which pass through the first through holes 102 and penetrate into the upper cover 11 of the socket shell 1 are arranged on two sides of the lower surface of each movable top cover 3 respectively; the connecting pins 31 are connected to ejecting part modules 4 arranged on two inner sides of the socket shell 1 respectively; the ejecting part modules 4 enable the movable top covers 3 to be in low positions in a normal state, and at the moment, a plug 5 may be inserted into the socket through the second plugholes 301 and the first plugholes 101 and is contacted with the terminal assembly 2 so as to be electrified; keys 41 exposed out of the two side walls of the socket shell 1 are arranged on the outer sides of the ejecting part modules 4 respectively; when the keys 41 are pressed, the movable top covers 3 are ejected out through the elastic ejecting part modules 4; and when the keys 41 are released, the movable top covers 3 are returned to the low positions through the elastic ejecting part modules 4, and the keys 41 are returned at the same time. When the movable top covers 3 are ejected out, the plug 5 is ejected out together, and the pins of the plug 5 and the terminal assembly 2 are released and even separated from the movable top covers 3; and when the keys 41 are released, the keys 41 will be returned while the movable top covers 3 are returned downwards; and therefore, the whole process can be performed with one hand; the socket can be returned to the original state, and other operations are not required, which greatly facilitates use.

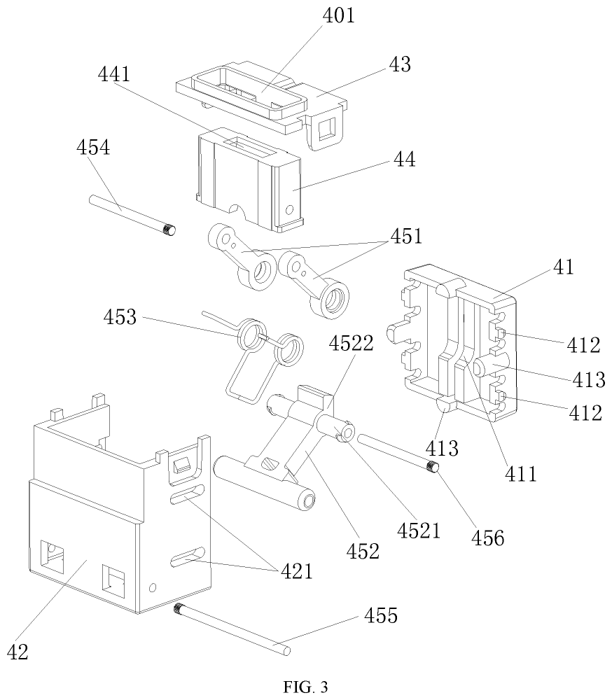

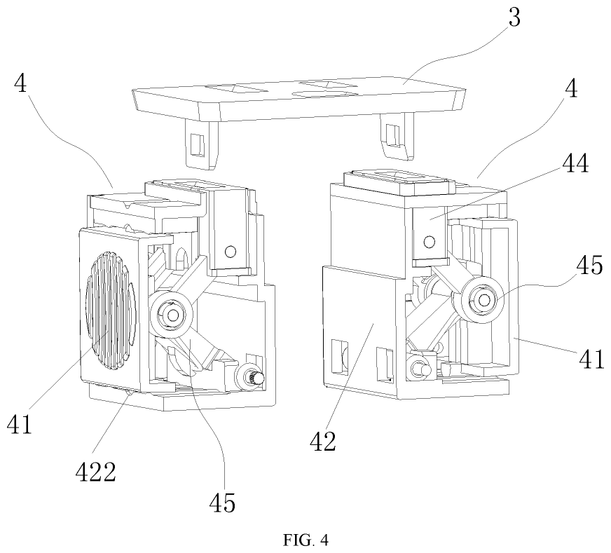

Specifically, referring to FIG. 3 and FIG. 4, each elastic ejecting part module 4 is provided with a box-shaped body 42 and a surface cover 43; a key 41 is arranged on the outer side surface of the box-shaped body 42; second through holes 401 aligned to the first through holes 102 are formed in the surface cover 43; ejecting parts 44 capable of penetrating through the second through holes 401 and the first through holes 102 are mounted in the second through holes 401; the upper parts of the ejecting parts 44 are connected to the connecting pins 31 of the movable top cover 3; the lower ends of the ejecting parts 44 are connected to the upper end part of the elastic assembly 45 arranged in the box-shaped body 42; the elastic assembly 45 includes a first connecting rod 451, a second connecting rod 452 and a torsional spring 453; the upper end part of the first connecting rod 451 is pivoted with the ejecting part 44 while the other end of the first connecting rod 451 is pivoted with one end of the second connecting rod 452; the other end of the second connecting rod 452 is pivoted at the inner bottom of the box-shaped body 42; a main body of the torsional spring 453 is arranged on a connecting part of the first connecting rod and the second connecting rod in a sleeving manner; one end of the torsional spring is connected with the first connecting rod 451 while the other end of the torsional spring 453 is connected with the second connecting rod 452; the upper end part of the first connecting rod 451 and the lower end part of the second connecting rod 452 are positioned in positions close to the inner side surface of the box-shaped body 42; the connecting part of the first connecting rod 451 and the second connecting rod 452 is outwardly propped against the inner side of the key 41; and when the torsional spring 453 is in a normal state, an included angle between the first connecting rod 451 and the second connecting rod 452 is in a decreasing trend, namely in a trend of clamping and downwards pulling the ejecting parts 44. Through the structure above, when the keys 41 are pressed, connecting part of first connecting rods 451 and second connecting rods 452 are rotated inwards and upwards, so that the first connecting rods 451 move upwards and upwards eject out the eject ejecting parts 44, and then the movable top covers 3 are driven by the ejecting parts 44 to be upwards ejected out; otherwise, when the keys 41 are released, the first connecting rods 451 and the second connecting rods 452 are returned to a clamping state through the elastic force of torsional springs 453, then the first connecting rods 451 pull the ejecting parts 44 and the movable top covers 3 is downwards pulled, thus movable top covers 3 are returned, and the keys 41 are returned at the same time.

Further, two first connecting rods 451 are arranged, and the upper end parts of the first connecting rods 454 are pivoted with the lower parts of the ejecting parts 44 through first connecting shafts 454; the upper part of the second connecting rod 452 extends towards two ends to form connecting parts 4521 to be connected with the first connecting rods 451 and used for sleeving the main body of the torsional spring 453; and the lower end part of the second connecting rod 452 is connected with the bottom of the box-shaped body 42 through a second connecting shaft 455. A second connecting shaft 455 may penetrate through the bottoms of the two side surfaces of a box-shaped body 42, or a pivoting seat is arranged at bottom of the box-shaped body 42, and the second connecting rods 452 rotate around the second connecting shaft 455; the two first connecting rods 451 enable the lifting motion of the ejecting parts 44 to be more balanced, and clamping caused by single-side imbalance is avoided; and in this embodiment, in order to further improve the stability, third a connecting shaft 456 is arranged in the upper part of the second connecting rod 452 in a penetrating mode.

A protruding to-be-pushed portion 4522 is arranged in the middle of the connecting part of each first connecting rod 451 and the second connecting rod 452; and correspondingly, an upward ejecting arc surface 411 corresponding to the to-be-pushed portion 4522 is arranged on the inner side of the key 41. Ejecting arc surface 411 is convenient for the keys 41 to push the connecting rods more smoothly, and also plays a role in supporting the connecting rods and keeping the keys and the connecting rods against each other in a normal state.

A limiting mechanism for preventing the key 41 from being separated is arranged in each elastic ejecting part module 4; the limiting mechanism includes clamping grooves 421 formed in two side surfaces of the box-shaped body 42, and buckling parts 412 which are arranged on two side surfaces of each key 41 and protrude outwards, and the buckling parts 412 are limited in the transversely-arranged clamping grooves 421, thereby preventing the key 41 from completely detaching from the elastic ejecting part module 4; guide blocks 413 are further arranged on the side surfaces and the bottom surfaces of the keys 41 and are matched with guide grooves 422 formed in the side surfaces and the bottom surfaces of the box-shaped bodies 42 and the face cover 43, so that the key 41 moves in and out along the guide groove 422 when pressed.

The ejecting parts 44 are a cuboid, correspondingly, the second through holes 401 in the surface cover 43 and the first through holes 101 in the upper cover 11 are rectangular, and connecting holes 441 which are connected to the connecting pins 31 of the movable top cover 3 in an inserting manner are formed in the ejecting parts. Buckles are arranged on the inner walls of the connecting holes 441 and are matched with clamping holes of the connecting pins 31, so that the connecting pins 31 and the ejecting parts 44 are prevented from being easily loosened;

Key holes 103 for exposing the keys 41 of the elastic ejecting part modules 4 are formed in two sides of the socket shell 1. In this example, the key holes 103 and the keys 41 are in a square shape, so that it is easy to press them with both hands.

A concave part 110 is arranged in the surface of the upper cover 11 of the socket shell 1; and the movable top cover 3 is arranged in the concave part 110, and the upper surface of the movable top cover does not protrude out of the upper surface of the upper cover 11 of the socket shell 1, so that the flatness and attractiveness of the overall appearance of the socket can be guaranteed.

The socket shell 1 includes the upper cover 11 and a bottom cover 12 which are integrated; the upper cover 11 and the bottom cover 12 are matched with each other to limit and fixedly arrange a plurality of groups of terminal assemblies 2; the elastic ejecting part modules 4 are respectively arranged in spaces on two sides of each group of terminal assemblies 2 in the socket shell 1; and the elastic ejecting part modules 4 are fixedly mounted on the upper cover 11 or the bottom cover 12, and are fixed by screws or clamping positions. That is, the elastic ejecting part modules are arranged on two sides of each inserting position of the socket respectively. The shape and the number of the socket plugholes may be adjusted according to actual requirements.

As shown in FIG. 1, when the plug 5 is plugged, the pins of the plug 5 are inserted into second plugholes 301 in the movable top covers 3 in an aligned manner, and the pins can be inserted through the first plugholes 101 in the upper cover 11 of the socket shell 1 and are in contact with the terminal assembly 2 to realize power supply; when the plug is pulled out, only the keys 41 exposed on the two sides of the socket shell 1 need to be pressed by hands, elastic assemblies 45 in two elastic ejecting part modules 4 eject up the ejecting parts 44, then the movable top covers 3 are ejected up, and the plug 5 will be driven to be ejected up and separated from the terminal assembly 2 in the socket and be in a release state; the plug can be pulled out with one hand after the keys are released; or the plug 5 can be directly ejected up to be separated from the movable top covers 3; and when the keys 41 are released, the keys 41 are returned through the elastic force of the elastic assemblies 45, and the ejecting parts 44 drive the movable top covers 3 to be returned at the same time.

In summary, according to the present invention, on the basis of an existing socket, the basic arrangement and specification of original terminal assemblies are not changed, the specification of the plug pin is not changed, and the fixed state of the terminal assemblies 2 is kept; the elastic ejecting part modules 5 and the movable top cover 4 are additionally arranged, the elastic ejecting modules 4 can be pressed with one hand to achieve the effect of ejecting and releasing the plug, and thus pulling out the plug with one hand is achieved; and moreover, after the elastic ejecting modules 4 are released, the movable top cover 3 can be automatically returned to the original state of the socket without other operations, and thus the convenience and the safety are greatly improved. In addition, the overall appearance of the socket according to the present invention can be kept the same as or close to that of a traditional socket, so that the safety and the service life are guaranteed; and the socket has a wide market prospect.

It is appreciated that the foregoing embodiments are only exemplary embodiments adopted to illustrate the principles of the present invention, but the present invention is not limited thereto. For those of ordinary skill in the art, various modifications and improvements can be made without departing from the spirit and essence of the present invention, and these modifications and improvements shall also fall within the scope of protection of the present invention.

What is claimed is:

1. A self-rebounding returning type socket capable of pulling a plug with one hand, comprising a socket shell and a terminal assembly arranged in the socket shell, a first plughole corresponding to the terminal assembly is formed in an upper cover of the socket shell, wherein: a movable top cover is also arranged above the first plughole in the upper cover of the socket shell, a second plughole corresponding to the first plughole is formed in the movable top cover; first through holes are formed in the upper cover of the socket shell and in the two sides of the first plughole respectively, connecting pins which pass through the first through holes and penetrate into the upper cover of the socket shell are arranged on two sides of the lower surface of the movable top cover respectively, the connecting pins are connected to elastic ejecting part modules arranged on two inner sides of the socket shell respectively, the elastic ejecting part modules enable the movable top cover to be in a low position in a normal state, keys exposed out of two side walls of the socket shell are arranged on the outer sides of the elastic ejecting part modules respectively, when the keys are pressed, the movable top cover is ejected out through the elastic ejecting part modules, and when the keys are released, the movable top cover is returned to the low position through the elastic ejecting part modules, and the keys are returned at the same time.

2. The self-rebounding returning type socket capable of pulling a plug with one hand according to claim 1, wherein each elastic ejecting part module is provided with a box-shaped body and a surface cover, a key is arranged on the outer side surface of the box-shaped body, second through holes aligned to the first through holes are formed in the surface cover, ejecting parts capable of penetrating through the second through holes and the first through holes are mounted in the second through holes, the upper parts of the ejecting parts are connected to the connecting pins of the movable top cover, the lower ends of the ejecting parts are connected to the upper end part of the elastic assembly arranged in the box-shaped body; the elastic assembly comprises a first connecting rod, a second connecting rod and a torsional spring, the upper end part of the first connecting rod is pivoted with the ejecting part while the other end of the first connecting rod is pivoted with one end of the second connecting rod, the other end of the second connecting rod is pivoted at the inner bottom of the box-shaped body, a main body of the torsional spring is arranged on a connecting part of the first connecting rod and the second connecting rod in a sleeving manner, one end of the torsional spring is connected with the first connecting rod while the other end of the torsional spring is connected with the second connecting rod, the upper end part of the first connecting rod and the lower end part of the second connecting rod are positioned in positions close to the inner side surface of the box-shaped body, the connecting part of the first connecting rod and the second connecting rod is outwardly propped against the inner side of the key; and when the torsional spring is in a normal state, an included angle between the first connecting rod and the second connecting rod is in a decreasing trend.

3. The self-rebounding returning type socket capable of pulling a plug with one hand according to claim 2, wherein two first connecting rods are arranged, and the upper end parts of the first connecting rods are pivoted with the lower parts of the ejecting parts through first connecting shafts, the upper part of the second connecting rod extends towards two ends to form connecting parts to be connected with the first connecting rods and used for sleeving the main body of the torsional spring, and the lower end part of the second connecting rod is connected with the bottom of the box-shaped body through a second connecting shaft.

4. The self-rebounding returning type socket capable of pulling a plug with one hand according to claim 2 , wherein a protruding to-be-pushed portion is arranged in the middle of the connecting part of each first connecting rod and the second connecting rod, and correspondingly, an upward ejecting arc surface corresponding to the to-be-pushed portion is arranged on the inner side of the key.

5. The self-rebounding returning type socket capable of pulling a plug with one hand according to claim 2, wherein a limiting mechanism for preventing the key from being separated is arranged in each elastic ejecting part module; the limiting mechanism includes clamping grooves formed in two side surfaces of the box-shaped body, and buckling parts which are arranged on two side surfaces of each key and protrude outwards, and the buckling parts are limited in the transversely-arranged clamping grooves; and guide blocks are further arranged on the side surfaces and the bottom surfaces of the keys and are matched with guide grooves formed in the side surfaces and the bottom surfaces of the box-shaped bodies.

6. The self-rebounding returning type socket capable of pulling a plug with one hand according to claim 2, wherein the ejecting parts are a cuboid, correspondingly, the second through holes in the surface cover and the first through holes in the upper cover are rectangular, and connecting holes which are connected to the connecting pins of the movable top cover in an inserting manner are formed in the ejecting parts; buckles are arranged on the inner walls of the connecting holes and are matched with clamping holes of the connecting pins.

7. The self-rebounding returning type socket capable of pulling a plug with one hand according to claim 1, wherein key holes for exposing the keys of the elastic ejecting part modules are formed in two sides of the socket shell.

8. The self-rebounding returning type socket capable of pulling a plug with one hand according to claim 1, wherein a concave part is arranged in the surface of the upper cover of the socket shell, and the movable top cover is arranged in the concave part, and the upper surface of the movable top cover does not protrude out of the upper surface of the upper cover of the socket shell.

9. The self-rebounding returning type socket capable of pulling a plug with one hand according to claim 1, wherein the socket shell comprises the upper cover and a bottom cover which are integrated, the upper cover and the bottom cover are matched with each other to limit and fixedly arrange a plurality of groups of terminal assemblies, the elastic ejecting part modules are respectively arranged in spaces on two sides of each group of terminal assemblies in the socket shell, and the elastic ejecting part modules are fixedly mounted on the upper cover or the bottom cover, and are fixed by screws or clamping positions.
